(19) United States
(12) Patent Application Publication
(10) Pub. No.: US 2007/0254212 A1
(43) Pub. Date: Nov. 1, 2007

(54) BATTERY ASSEMBLY FOR USE IN IMPLANTABLE MEDICAL DEVICE

(76) Inventor: Joseph J. Viavattine, Vadnais Heights, MN (US)

Correspondence Address: MEDTRONIC, INC., 710 MEDTRONIC PARKWAY NE, MINNEAPOLIS, MN, 55432-9924, US

(21) Appl. No.: 11/380,775

(22) Filed: Apr. 28, 2006

(51) Int. Cl. H01M 2/02; H01M 2/06

(52) U.S. Cl. 429/164; 429/94; 429/178

(57) ABSTRACT

A battery assembly comprises a housing including first and second concentric walls, and a first electrode assembly substantially disposed between the first and second concentric walls. A second electrode assembly is substantially surrounded by the second wall. The first electrode assembly may be coiled around the second wall, and the housing may further comprise cover that is fixedly coupled to an edge of the second wall.

### TECHNICAL FIELD

This invention relates generally to an implantable medical device (IMD) and, more particularly, to a battery assembly for use within an IMD.

### BACKGROUND OF THE INVENTION

A wide variety of implantable medical devices (IMDs) exists today, including various types of pacemakers, cochlear implants, defibrillators, neurostimulators, and active drug pumps. Though IMDs may vary in function and design, many have common design features and goals. It is a common goal, for example, that every IMD should be made as compact as possible, without sacrificing device performance, so as to minimize the amount of discomfort that implantation of the device might cause a patient. Additionally, virtually every IMD must be provided with some type of power source, typically an electrochemical cell or battery, which occupies space within the canister of the IMD. The size of an IMD's battery may thus have a strong impact on the overall size and shape of the IMD. Moreover, the battery's capacity often determines how long an IMD may remain implanted without the need for replacement. In view of this, a primary goal in the production of IMDs is to maximize battery energy/power density; i.e., the amount of energy/power per unit weight or per unit volume of the battery.

The battery of an IMD typically comprises a metal housing (e.g., titanium, aluminum, steel, etc.) having a cavity therein that houses an electrode assembly. The electrode assembly, which is electrically insulated from the housing by an insulative body (e.g., a polypropylene insert), may comprise an anode, a cathode, and one or more insulative separator sheets (e.g., a polymeric film) disposed intermediate the anode and cathode. Each electrode may include a lead or tab extending therefrom that is electrically coupled (e.g., welded) to, for example, the canister of the IMD or to circuitry disposed within the IMD. The canister is typically filled with an electrolytic fluid to provide a medium for ionic conduction between the anode and the cathode. An IMD may employ any one of a variety of battery designs, including button/coin, pouch, and prismatic cell stack designs. However, spiral wound batteries, which utilize coiled electrode assemblies to increase the active surface area of the electrodes, are often preferred for use in IMDs because of their volumetric efficiency.

Outside of the IMD context, many devices are known that employ multiple batteries. A second (or third) battery may provide a redundant power source if the main battery should fail. Multiple battery systems also permit the simultaneous use of different battery types (e.g., high-power vs. low-power, primary vs. secondary, etc.). Devices employing multiple batteries may utilize the unique capabilities of each battery type to perform various device functions. Despite these advantages, multiple battery systems are not typically utilized in IMDs due to the resultant increase in occupied space.

It should thus be appreciated that it would be desirable to provide a battery assembly suitable for use in an implantable medical device having a relatively high energy/power density. It should also be appreciated that it would be advantageous if such a battery assembly employed multiple independent batteries/electrode assemblies, each of which may be chosen to have different characteristics (e.g., battery chemistries) and each of which may be utilized to power different device functions. Furthermore, other desirable features and characteristics of the present invention will become apparent from the subsequent detailed description of the invention and the appended claims, taken in conjunction with the accompanying drawings and this background of the invention.

### BRIEF DESCRIPTION OF THE DRAWINGS

The following drawings are illustrative of particular embodiments of the invention and therefore do not limit the scope of the invention, but are presented to assist in providing a proper understanding. The drawings are not to scale (unless so stated) and are intended for use in conjunction with the explanations in the following detailed descriptions. The present invention will hereinafter be described in conjunction with the appended drawings, wherein like reference numerals denote like elements, and:

FIG. 1 is an isometric view of a battery assembly in accordance with a first embodiment of the present invention;

FIGS. 2 and 3 are partially and fully exploded views, respectively, of the battery assembly shown in FIG. 1;

FIG. 4 is a top view of a segment of the coiled electrode assembly shown in FIGS. 2 and 3;

FIG. 5 is an exploded view an implantable medical device;

FIG. 6 is an isometric cutaway view of a pulse generator employed in the implantable medical device shown in FIG. 5 incorporating the battery assembly shown in FIGS. 1-3; and

FIGS. 7 and 8 are exploded of battery assemblies in accordance with second and third embodiments, respectively, of the present invention.

### DETAILED DESCRIPTION OF THE EXEMPLARY EMBODIMENT

The following description is exemplary in nature and is not intended to limit the scope, applicability, or configuration of the invention in any way. Rather, the following description provides a convenient illustration for implementing an exemplary embodiment of the invention. Various changes to the described embodiment may be made in the function and arrangement of the elements described herein without departing from the scope of the invention.

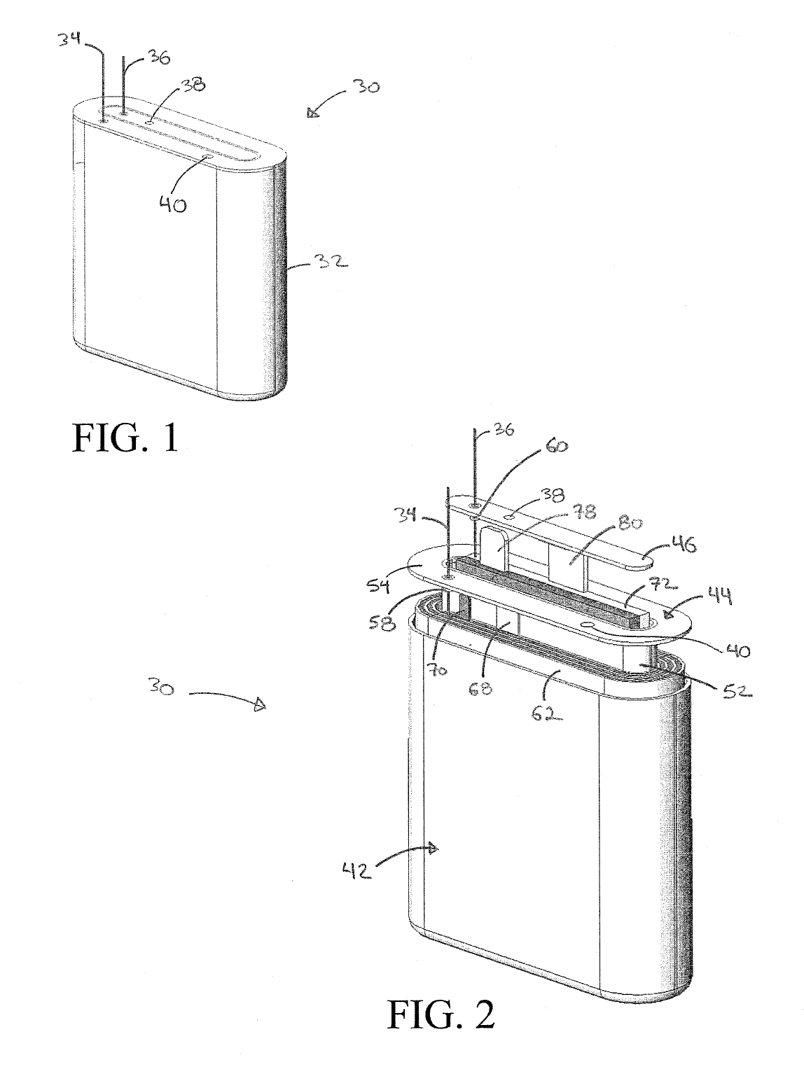

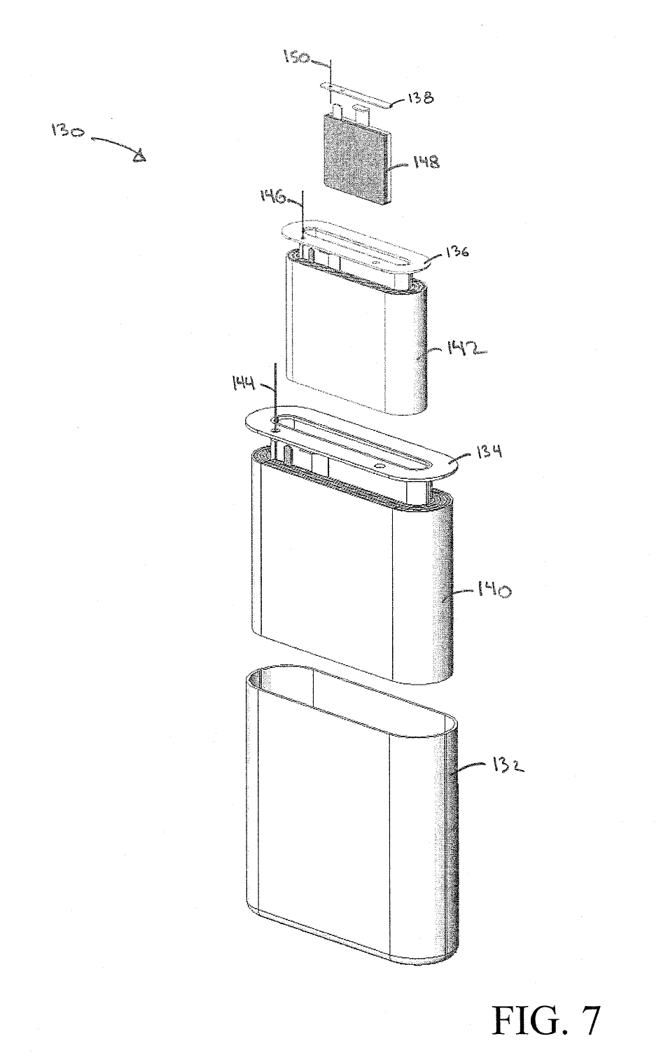

FIG. 1 is an isometric view of a battery assembly 30 in accordance with a first embodiment of the present invention. Battery assembly 30 comprises a housing 32, which may comprise a generally cylindrical, metal body (e.g., titanium, aluminum, stainless steel, or other metal or alloy). A first lead (e.g., a niobium pin) 34 and a second lead 36 (e.g., a niobium pin) extend through housing 32. The protruding ends of pins 34 and 36 may each be electrically coupled to, for example, circuitry deployed on an implantable medical device as described below in conjunction with FIG. 6. First and second fill ports 38 and 40 are also provided through housing 32. Fill ports 38 and 40 each permit the introduction of an electrolytic fluid into a different interior compartment provided within assembly 30. The electrolytic fluid enables ionic communication between electrodes disposed within each interior compartment, as will also be more fully described below. After each compartment has been filled with electrolytic fluid, covers (not shown) may be placed over fill port 38 and over fill port 40 and fixedly coupled (e.g., laser welded) to housing 32.

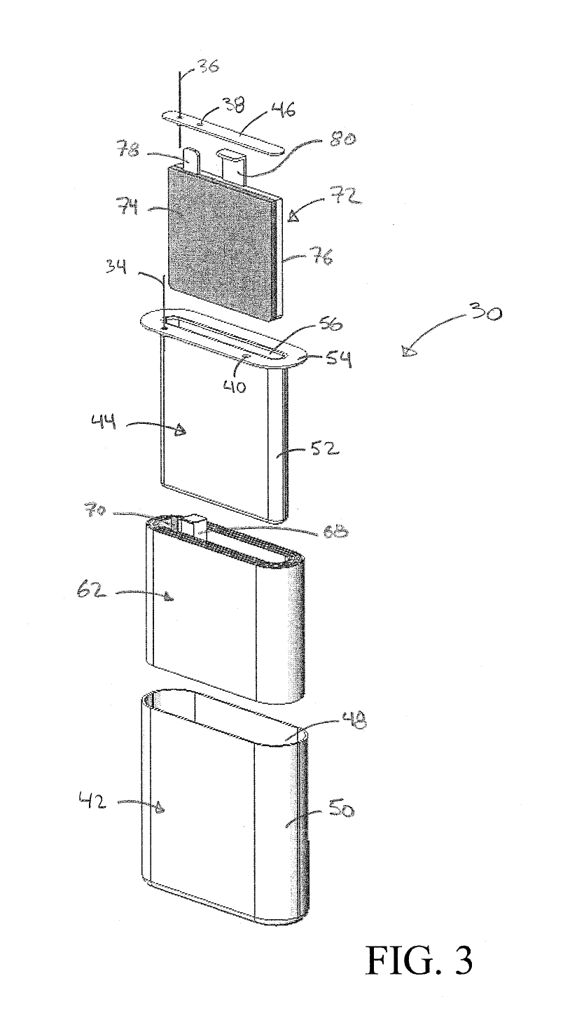

FIGS. 2 and 3 are partially and fully exploded views, respectively, of battery assembly 30. Here, it may be seen that housing 32 consists of three components: an outer case 42, an inner case 44, and a central cover 46. Outer case 42 has a cavity 48 therein and comprises a tubular outer wall 50. Inner case 44 comprises a tubular inner wall 52, a rim portion 54 extending from inner wall 52, and an interior compartment 56 (FIG. 3). Inner case 44 may be inserted into outer case 42 as indicated in FIG. 2, and rim portion 54 may be laser welded to the upper peripheral edge of outer wall 50. When inner case 44 is inserted into outer case 42 in this manner, outer wall 50 is positioned so as to be substantially concentric with inner wall 52. The inner diameter of outer wall 50 is substantially greater than the outer diameter of inner wall 52; thus, walls 52 and 50 cooperate to form an inner annular compartment there between. As will be seen, a first electrode assembly (e.g., a coiled electrode assembly) 62 may be disposed within this annular compartment, and a second electrode assembly (e.g., a plate electrode assembly) 74 may be disposed within interior compartment 56 of inner case 44.

Terminal pins 34 and 36 are each guided through, and electrically insulated from, housing 32 by a feedthrough assembly. In particular, terminal pin 34 is guided through rim portion 54 of inner case 44 by a first feedthrough assembly 58, and terminal pin 36 is guided through central cover 46 by a second feedthrough assembly 60. Feedthrough assemblies 58 and 60 are well known in the art and may comprise, for example, a metal ferrule (e.g., titanium) having an insulative structure (e.g., glass) disposed therein. The insulative structure secures and insulates terminal pins 34 and 36 within their respective ferrules. The insulative structures also form a hermetic seal within each of the ferrules.

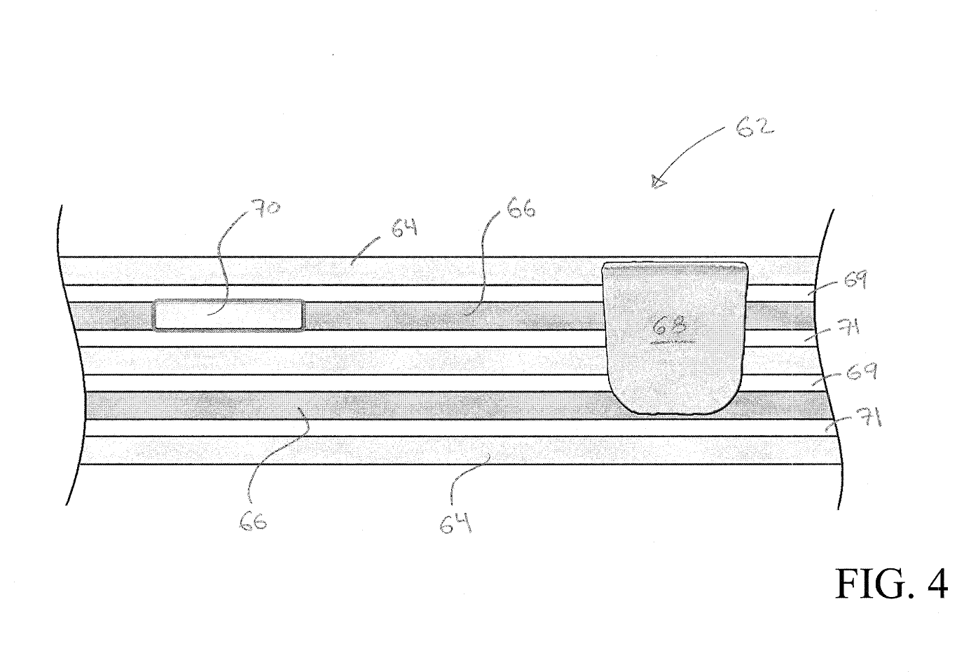

As previously stated, a first electrode assembly 62 resides within the annular compartment formed between outer wall 50 and inner wall 52. In the exemplary embodiment, electrode assembly 62 is a spiral wound or coiled electrode assembly that is disposed around inner wall 52 of inner case 44 to form a torroidal battery. As can be seen in FIG. 4, a top view of a segment of assembly 62, electrode assembly 62 comprises a first electrode 64 (e.g., an anode), a second electrode 66 (e.g., a cathode), a first separator layer 69, and a second separator layer 71. Separator layers 69 and 71 comprise a porous separator material (e.g., a polymeric film, such as polypropylene, polyethylene, etc.) that permits the passage of ions while precluding physical contact between electrodes 64 and 66. Electrodes 64 and 66 are initially produced as relatively long strips of foil that are coiled about a mandrel to form the annular body of assembly 62. During the coiling process, separator layer 71 is placed over electrode 64, electrode 66 is placed over layer 71, and then separator layer 69 is placed over electrode 66. Next, the resulting laminate is coiled around a mandrel (e.g., a tube or disc having an outer diameter equivalent to, or slightly larger than, the outer diameter of inner wall 52). The mandrel is then removed and coiled electrode assembly 62 is placed within the annular compartment formed by outer wall 50 and inner wall 52. Alternatively, the resulting laminate may simply be coiled around inner wall 52, and coiled electrode assembly 62 and inner case 44 may be lowered into outer case 42.

Electrodes 64 and 66 may each comprise a body of active material (e.g., an anode-type metal, such as lithium; or a cathode-type mix, such as silver vanadium oxide powder) having a current collector disposed therein. The current collector may take of the form of a flattened metal plate (e.g., titanium) having a plurality (e.g., a grid) of apertures therethrough. Electrodes 64 and 66 are each provided with a lead extending therefrom that may serve as an electrical contact. For example, as shown in FIGS. 2-4, electrodes 64 and 66 may be provided with respective tabs 68 and 70. If electrode 64 or electrode 66 includes a current collector, tab 68 or 70 may comprise an exposed portion of an elongated stem extending from the body of the current collector. Tab 68 may be welded to rim portion 54 to electrically couple electrode 64 to inner case 44. In a similar manner, tab 70 may be welded to terminal pin 34 to electrically couple electrode 66 to, for example, circuitry coupled to the protruding end of pin 34 (FIGS. 2 and 3). Tabs 68 and 70 each extend upward and away from electrodes 64 and 66 to provide headspace between electrode assembly 62 and rim portion 54. In this way, tabs 68 and 70 help provide a generally safe weld zone and additional space for electrolytic fluid. A bi-polymer insulative cover (not shown) having two apertures therethrough to accommodate tabs 68 and 70 may be disposed within this headspace to further insulate electrode assembly 62 from the conductive housing of battery assembly 30.

Referring again to FIGS. 2 and 3, a second electrode assembly 72 is disposed within interior compartment 56 provided in inner case 44. Electrode assembly 72 may be, for example, a plate electrode assembly comprising a first electrode plate 74 (e.g., a cathode) and a second electrode plate 76 (e.g., an anode). As was the case with electrodes 64 and 66, electrodes 74 and 76 may each comprise a body of active material having a current collector (e.g., a flattened metal plate) disposed therein. Plate electrodes 74 and 76 are each provided with a lead (i.e., tabs 78 and 80, respectively) extending therefrom that may serve as an electrical contact. Tab 78 may be welded to terminal pin 36 to electrically couple electrode plate 74 to, for example, circuitry coupled to the protruding end of pin 36 (FIGS. 2 and 3). Tab 80 may be welded to central cover 46 to electrically couple electrode plate 76 to the conductive casing of battery assembly 30. As electrode 64 is also electrically coupled to the casing of assembly 30, electrode plate 76 and electrode 64 should share the same terminal charge (i.e., electrodes 76 and 64 should both be anodes or cathodes).

It should be appreciated from the forgoing description that the inventive battery assembly (e.g., assembly 30) comprises multiple, independent electrode assemblies (e.g., assemblies 62 and 72) that reside within a unitary housing (e.g., housing 32). By employing a unitary housing in this manner, the inventive battery assembly substantially increases the power/energy density relative to known multiple battery systems wherein each battery is provided with an independent encasement. This design also permits a multiple batteries to be deployed within a single unit that may be easily manipulated and connected to other components deployed on an IMD. Furthermore, the electrode assemblies (e.g., assemblies 62 and 72) reside within independent compartments provided within the battery (e.g., assembly 30), which may each be filled with a different electrolytic fluid. This allows the individual chemistries of the electrode assemblies to be independently selected to suit a particular application or device feature. For example, electrode assembly 62 may be chosen to have a primary chemistry (e.g., lithium manganese dioxide), while electrode assembly 72 may be chosen to have a secondary (i.e., rechargeable) chemistry.

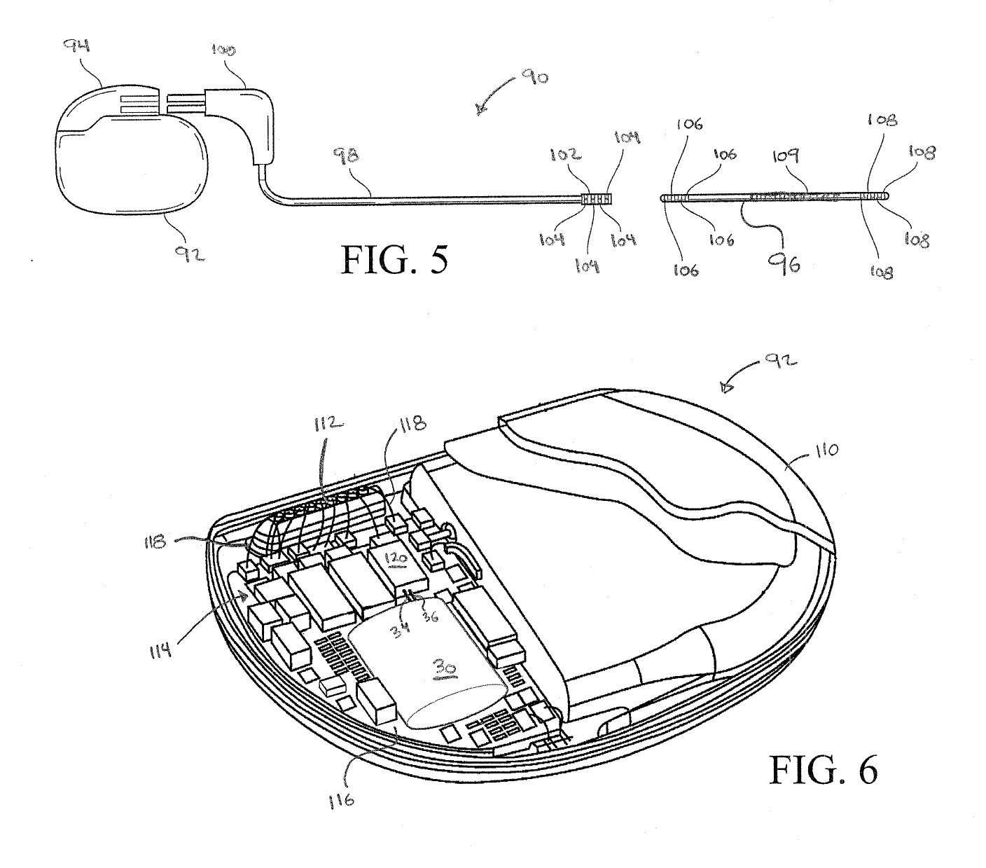

Due to its volumetric efficiency and other associated advantages described herein, battery assembly 30 is ideal for implementation within an IMD. FIG. 5 is an exploded view of an implantable medical device 90 including a pulse generator 92 in which battery assembly 30 may be employed. Pulse generator 92 includes a connector block 94, which is coupled to a lead 96 by way of an extension 98. The proximal portion of extension 98 comprises a connector 100 configured to be received or plugged into connector block 94, and the distal end of extension 98 likewise comprises a connector 102 including internal electrical contacts 104. Electrical contacts 104 are configured to receive the proximal end of lead 96 having a plurality of electrical contacts 106 disposed thereon. The distal end of lead 96 includes distal electrodes 108, which may deliver therapy (e.g., pacing pulses) to a patient's heart and/or sense cardiac signals. Finally, a coiled electrode 109 is provided on a medial portion of lead 96 and may be utilized to deliver defibrillating pulses to the patient's heart.

FIG. 6 is an isometric cutaway view of pulse generator 92 (FIG. 5) illustrating one manner in which battery assembly 30 may be deployed within an implantable medical device. Pulse generator 92 comprises a canister 110 (e.g. titanium or other biocompatible material) having an aperture therein through which a multipolar feedthrough assembly 112 is disposed. Circuitry 114 is provided within pulse generator 92 and mounted on a printed circuit board 116. Circuitry 114 is coupled to each of the terminal pins of feedthrough assembly 112 via a plurality of connective wires 118 (e.g., gold). Battery assembly 30 may also be mounted on circuit board 116, and terminal pins 34 and 36 may each be coupled to a component of circuitry 114, such as connector chip 120. Battery assembly 30 is configured to power to pulse generator 92 and enable IMD 90 to deliver therapy to treatment sites within a patient's body. In particular, pulse generator 92 may selectively utilize electrode assemblies 62 and 72 to power different device functions. For example, circuitry 114 may monitor the output voltage appearing at terminal pin 34 to determine the remaining life of electrode assembly 62. If the voltage drops below a threshold value, circuitry 114 may utilize electrode assembly 72 to activate a patient alert and/or to provide a reserve power source. Alternatively, IMD 90 may utilize electrode assembly 62 to deliver low level pacing pulses to a patient's heart via electrodes 108 (FIG. 5), or to perform diagnostic and telemetry functions that enable wireless communication with an external programmer.

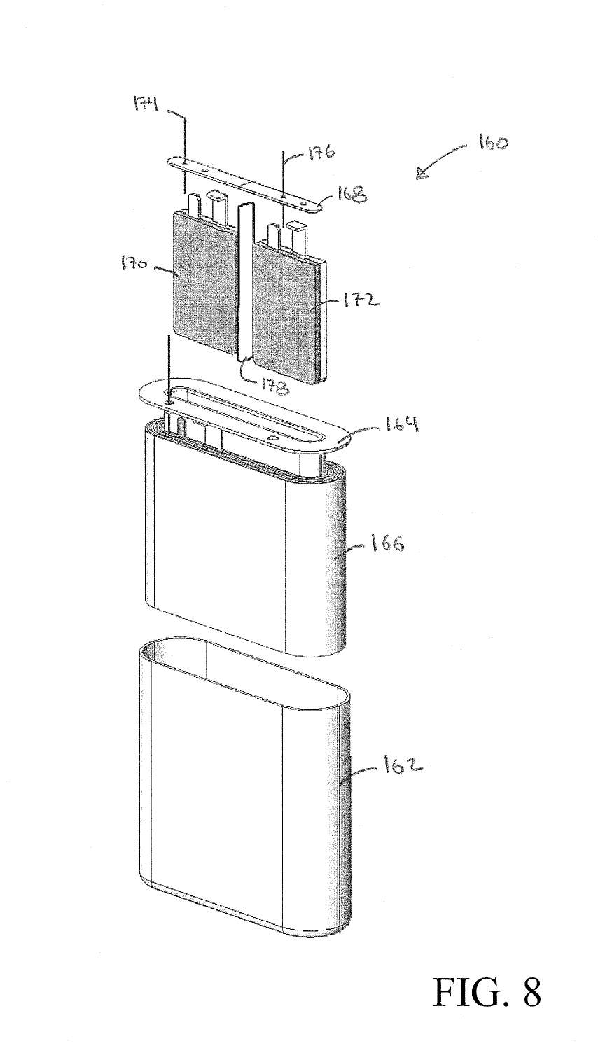

While the inventive battery assembly has been described thus far as incorporating two independent batteries/electrode assemblies, it should be appreciated that three or more electrode assemblies may also be employed. To further illustrate this point, FIGS. 7 and 8 provide isometric views of battery assemblies 130 and 160, respectively, in accordance with second and third embodiments of the present invention. Referring first to FIG. 7, it may be seen that battery assembly 130 comprises an outer casing 132, an intermediate casing 134, an inner casing 136, and a central cover 138. First and second coiled electrode assemblies 140 and 142 are disposed around the inner walls of casings 134 and 136, respectively, and electrically coupled to terminal pins 144 and 146. Intermediate casing 134 and inner casing 136 each have a cylindrical interior. Intermediate casing 134 and electrode assembly 140 may be inserted into the cavity provided in outer casing 132, and the outer rim of casing 134 may be welded to the upper edge of casing 132 as described above in conjunction with electrode assembly 30 (FIGS. 1-6). A third electrode assembly 148 (e.g., a plate electrode assembly) is disposed within the interior compartment of inner casing 136. After electrode assembly 148 has been so disposed, cover 138 is fixedly covered to inner case 136 to enclose the interior compartment provided therein. Electrical communication is provided to electrode assembly 148 via a terminal pin 150 that extends through central cover 138. Battery assembly 130 may be disposed within a medical device (e.g., pulse generator 92), and electrodes assemblies 140, 142, and 148 may be coupled to circuitry disposed within the device via terminal pins 144, 146, and 150, respectively, as described above.

FIG. 8 is an exploded view of a battery assembly 160 in accordance with a third embodiment of the present invention. Battery assembly 160 is similar to battery assembly 30 (FIGS. 1-6); battery assembly 160 comprises an outer casing 162, an inner casing 164 having a first electrode assembly 166 coiled there around, and a central cover 168. Unlike battery assembly 30, however, battery assembly 160 includes first and second electrode assemblies 170 and 172 that are adjacently disposed within inner casing 164. Assemblies 170 and 172 may each be plate-type assemblies, and are coupled to terminal pins 174 and 176, respectively. Electrode assemblies 170 and 172 are separated by an insulative divider 178 that precludes contact between the electrode assemblies and provides separation of the electrolytic fluids. By employing a third electrode assembly, battery assemblies 130 and 160 each increase the number of battery chemistries that may be employed.

In view of the above, it should be appreciated that a battery assembly has been provided suitable for use in an implantable medical device having a relatively high energy/power density. It should further be appreciated that the described battery assembly employs multiple independent batteries, each of which may be chosen to have different characteristics (e.g., battery chemistries) and may be utilized to power different device functions. Although the invention has been described with reference to a specific embodiment in the foregoing specification, it should be appreciated that various modifications and changes can be made without departing from the scope of the invention as set forth in the appended claims. Accordingly, the specification and figures should be regarded as illustrative rather than restrictive, and all such modifications are intended to be included within the scope of the present invention.

What is claimed is:

1. A battery assembly, comprising:
a housing including first and second concentric walls;
a first electrode assembly substantially disposed between said first and second concentric walls; and
a second electrode assembly substantially surrounded by said second wall.

2. A battery assembly according to claim 1 wherein said first electrode assembly is substantially coiled around said second wall.

3. A battery assembly according to claim 1 wherein said housing further comprises a cover fixedly coupled to an edge of said second wall.

4. A battery assembly according to claim 3 further comprising a feedthrough assembly disposed through said cover and electrically coupled to said second electrode assembly.

5. A battery assembly according to claim 1 further comprising a third electrode assembly substantially surrounded by said second wall.

6. A battery assembly according to claim 5 wherein said third electrode assembly is disposed adjacent said second electrode assembly.

7. A battery assembly according to claim 5 wherein said housing further includes a third wall that is substantially concentric with said second wall, said second electrode assembly substantially disposed between said second wall and said third wall, and said third electrode assembly substantially surrounded by said third wall.

8. A battery assembly for use in an implantable medical device, comprising:
an outer casing having a cavity therein;
an inner casing disposed substantially within the cavity, said inner casing comprising:
a tubular wall having an outer surface and an inner surface substantially forming an interior compartment; and
a rim portion extending from said tubular wall and coupled to said outer casing;
a cover coupled to said inner housing and substantially enclosing the interior compartment;
a first electrode assembly disposed around said outer surfaced; and
a second electrode assembly residing within the interior compartment.

9. A battery assembly according to claim 8 wherein said outer casing and said outer surface cooperate to form an inner annular compartment in which said first electrode assembly is disposed.

10. A battery assembly according to claim 8 wherein said first electrode assembly is a coiled electrode assembly.

11. A battery assembly according to claim 8 wherein said inner casing further comprises a central opening therein to said interior compartment, said rim portion extending from said tubular wall proximate the central opening.

12. A battery assembly according to claim 8 wherein said first electrode assembly includes at least one tab extending therefrom toward said cover.

13. A battery assembly according to claim 8 further comprising a first port through said rim portion and a second fill port through said cover.

14. A battery assembly according to claim 8 further comprising:
a first terminal pin extending through said rim portion and electrically coupled to said first electrode assembly; and
a second terminal pin extending through said cover and electrically coupled to said second electrode assembly.

15. A battery assembly according to claim 14 further comprising:
a first feedthrough assembly disposed around said first terminal pin and fixedly coupled to said rim portion, said first feedthrough assembly for insulatively guiding said first terminal pin through said rim portion; and
a second feedthrough assembly disposed around said second terminal pin and fixedly coupled to said cover, said first feedthrough assembly for insulatively guiding said first terminal pin through said cover.

16. An implantable medical device, comprising:
a canister;
circuitry disposed within said canister; and
a battery assembly disposed within said housing and coupled to said circuitry, said battery assembly comprising:
a torroidal battery including a first electrode assembly and a housing having an inner wall and an outer wall, said first electrode assembly disposed between said inner wall and said outer wall; and
a second electrode assembly substantially surrounded by said inner wall.

17. An implantable medical device according to claim 16 wherein said first electrode assembly is a coiled electrode assembly, and wherein said second electrode assembly is a plate electrode assembly.

18. An implantable medical device according to claim 16 wherein said first electrode assembly comprises:
a first electrode;
a second electrode; and
at least one layer of separator material disposed between said first electrode and said second electrode.

19. An implantable medical device according to claim 18 where said battery assembly further comprises a lead through said housing, said lead having a first end coupled to said first electrode and a second end coupled to said circuitry.

20. An implantable medical device according to claim 18 wherein said first electrode assembly is electrically coupled to said housing.
